(19) United States
(12) Patent Application Publication
(10) Pub. No.: US 2022/0300761 A1
(43) Pub. Date: Sep. 22, 2022

(54) SYSTEMS AND METHODS FOR HIERARCHICAL MULTI-LABEL CONTRASTIVE LEARNING

(71) Applicant: salesforce.com, inc., San Francisco, CA (US)

(72) Inventors: Shu Zhang, Fremont, CA (US); Chetan Ramaiah, San Bruno, CA (US); Caiming Xiong, Menlo Park, CA (US); Ran Xu, Mountain View, CA (US)

(21) Appl. No.: 17/328,779

(22) Filed: May 24, 2021

Related U.S. Application Data
(63) Continuation of application No. 63/162,405, filed on Mar. 17, 2021.

(51) Int. Cl. G06K 9/62; G06N 3/08

(52) U.S. Cl. CPC G06K 9/6256; G06K 9/6228; G06N 3/08

(57) ABSTRACT

Embodiments described herein provide a hierarchical multi-label framework to learn an embedding function that may capture the hierarchical relationship between classes at different levels in the hierarchy. Specifically, supervised contrastive learning framework may be extended to the hierarchical multi-label setting. Each data point has multiple dependent labels, and the relationship between labels is represented as a hierarchy of labels. The relationship between the different levels of labels may then be learnt by a contrastive learning framework.

### CROSS REFERENCES

The application is a non-provisional of and claims priority under 35 U.S.C. 119 to U.S. provisional application No. 63/162,405, filed Mar. 17, 2021, which is hereby expressly incorporated by reference herein in its entirety.

### TECHNICAL FIELD

The embodiments relate generally to machine learning systems and computer vision, and more specifically to a hierarchical multi-label contrastive learning framework.

### BACKGROUND

Machine learning systems have been widely used in computer vision, e.g., in pattern recognition, object localization, and/or the like. Such machine learning systems may be trained using a large amount of training images that are pre-annotated with labels (supervised), or without pre-annotated labels (unsupervised). A particular type of learning framework is the contrastive learning-based representation learning framework, which can be implemented in the unsupervised or supervised settings. Contrastive learning typically relies on minimizing the distance between representations of a positive pair of samples, while maximizing the distance between negative pairs. Specifically, positive pairs are constructed by an anchor image and a matching image, whereas negative pairs are the anchor image and un-related images. For example, in the unsupervised (self-supervised) setting, the positive pairs may be obtained by different views of the same image, most typically obtained by random augmentations of the anchor image. In the supervised setting, the available labels from the training data may be used to construct a wider variety of positive pairs, from different images of the same class and their augmentations. However, existing contrastive learning frameworks, in particular supervised learning frameworks, often focus on using only a single label to learn representations, which limits the accuracy of the representation on unseen data and different downstream tasks.

### BRIEF DESCRIPTION OF THE DRAWINGS

FIG. 1A is a simplified diagram illustrating a visualization of different image representations in the feature space, according to one embodiment described herein.

FIG. 1B is a simplified diagram illustrating an example hierarchical multi-label structure containing example images shown in FIG. 1A, according to one embodiment described herein.

FIG. 2 is a simplified diagram illustrating a framework 200 for hierarchical contrastive learning with a hierarchical multi-label structure such as shown in FIG. 1B, according to embodiments described herein.

FIG. 3 provide an example visualization of the effects of the various losses on the data samples in the embedding space, according to embodiments described herein.

FIG. 4 is a simplified diagram of a computing device that implements a hierarchical multi-label contrastive learning framework, according to some embodiments described herein.

FIG. 5 is a simplified diagram of a method 500 for training a multi-view contrastive relational learning framework, according to some embodiments, according to some embodiments described herein.

FIGS. 6-13 provide example data performance results according to experiments on the framework and/or methods described in FIGS. 2-5, according to embodiments described herein.

In the figures, elements having the same designations have the same or similar functions.

### DETAILED DESCRIPTION

Contrastive learning has been widely used in machine learning systems. In contrastive learning, the loss objective may attempt to minimize the distances between augmented versions of the same image, e.g., positive pairs, but in unsupervised approaches the loss functions are not directly optimizing for any of the down-stream tasks. Many unsupervised approaches rely on a pre-text task to learn an efficient embedding. These tasks usually need no supervision, or their supervision signals can be derived from the data itself. In the supervised setting, positive or negative pairs for contrastive learning can be constructed from augmentations of an anchor image, or by using the label to get other images of the same class. In general, positive pairs constructed from augmentations of the anchor image, and pairs constructed from the anchor image and other images of the same class are considered to be equivalent, and the learning process attempts to minimize the distance between images in all of these positive pairs to the same degree. While representations learned in this paradigm may be satisfactory for a downstream task based on the supervisory label such as category prediction, other tasks such as sub-category prediction or retrieval, attribute prediction or clustering can suffer due to the absence of direct supervision for these tasks.

In addition, existing contrastive approaches do not support multi-label learning and are unable to utilize information about the relationship between labels. Current solutions involve training a separate super-vised network for each downstream task, or for each label type/level. This per-task learning mechanism can be expensive with a large number of downstream tasks and a large amount of unseen data.

Specifically, in the real world, hierarchical multi-labels may occur naturally and frequently. For example, biological classification of organisms may be structured in a taxonomic hierarchy. For another example, in e-commerce web-sites, retail spaces and grocery stores, products are organized by several levels of categories. However, representation learning approaches that exploit this hierarchical relationship between labels have been under developed.

In view of the inaccuracy of single-label or single-task learning mechanisms and the need of multi-level labels, embodiments described herein provide a hierarchical multi-label framework to learn an embedding function that may capture the hierarchical relationship between classes at different levels in the hierarchy. Specifically, supervised contrastive learning framework may be extended to the hierarchical multi-label setting. Each data point has multiple dependent labels, and the relationship between labels is represented as a hierarchy of labels. A set of constraints may be designed to force images with shared hierarchical multi-labels closer together. The constraints may be data driven and may automatically adapt to arbitrary multi- label structures with minimal tuning.

In one embodiment, a general representation learning framework is developed to utilize all available ground truth information for a given dataset and learn embeddings that generalize to a variety of downstream tasks. In this learning framework, two types of losses learn the relationship between hierarchical multi-labels and representations that can retain the label relationship in the representation space. On one hand, the Hierarchical Multi-label Contrastive Loss (HMCL) enforces a penalty that is dependent on the proximity between the anchor image and the matching image in the label space. In the hierarchical multi-label setting, proximity is defined in the label space as the overlap in ancestry in the tree structure. On the other hand, the Hierarchical Constraint Enforcing Loss (HCEL) prevents the hierarchy violation, which is, to ensure that the loss from pairs farther apart in the label space are never less than the loss from pairs that are closer. In this way, embeddings generated from this approach can then be used in a variety of downstream tasks to enhance downstream task performance.

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

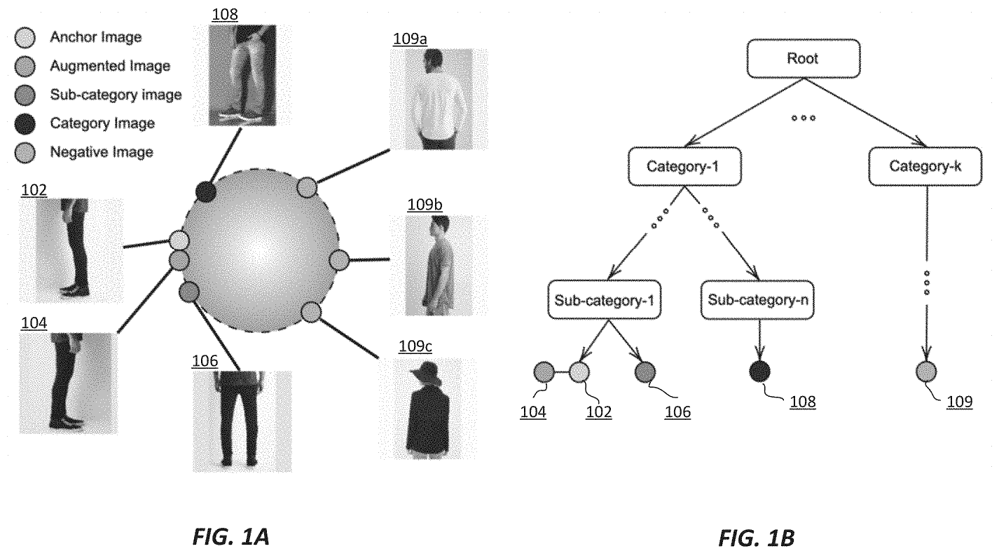

FIG. 1A is a simplified diagram illustrating a visualization of different image representations in the feature space, according to one embodiment described herein. The anchor image 102 and the augmented image 104 of the anchor image 102 belong to a specific product in the category “DENIM”, the sub-category image 106 is also from the same product, and the category image 108 is from a different product in the same category. All the negative images 109a-c in the example are from other categories.

In this example, the anchor image 102 is of the DENIM category in DeepFashion (a dataset comprising multi-labels of clothing items), and nodes corresponding to images 102-108 indicate their relationship to the anchor image 102 in the representation space, with increasing distance from the anchor image 102. Except for the augmented image 104, the distance from the anchor image 102 also corresponds to fewer common ancestors in the multi-label space. The negative images 109a-c are from different categories in the dataset and hence for negative pairs with the anchor image 102.

FIG. 1B is a simplified diagram illustrating an example hierarchical multi-label structure containing example images shown in FIG. 1A, according to one embodiment described herein. As used herein, the term “hierarchical multi-label dataset” refers to a dataset in which each data sample is associated with multiple dependent labels, and the dependency can be described in a directed acyclic graph or a tree. For example, Leaf nodes represent a unique image identifier, and all non-leaf nodes in the tree represent labels at various levels. The levels are analogous to depth in a tree structure, with higher levels corresponding to broader categories (closer to the root of the tree). The highest level corresponds to the category label.

As shown in FIG. 1B, a tree structure is used to visualize the multi-labels corresponding to images 102, 104, 106, 108 and 109. Given a hierarchical label structure, positive pairs may be constructed from images that share common labels at all levels in the hierarchy. In this way, a learning objective may be defined to force positive images closer together, but the magnitude of the force is dependent on the commonality level of the pair's labels. For example, images in the same subcategory at a lower level such as 102, 104 and 106 will be pulled closer in the feature space than with image 108 that is in a different subcategory, although images 102, 104, 106 and 108 all belong to the same category “denim.” Thus, the “DENIM” category would be the highest label for the anchor image 102, and “sub-category-1” would be the lowest level label.

At each level 1, positive pairs are formed by identifying a pair of images that have common ancestry up to level 1 and diverge thereafter. For example, the anchor image 102 and the category image 108 form a pair at the category level, as they only have the category label to be common between them. In graph terminology, a pair of images at level 1 implies that they will have their lowest common ancestor at level 1.

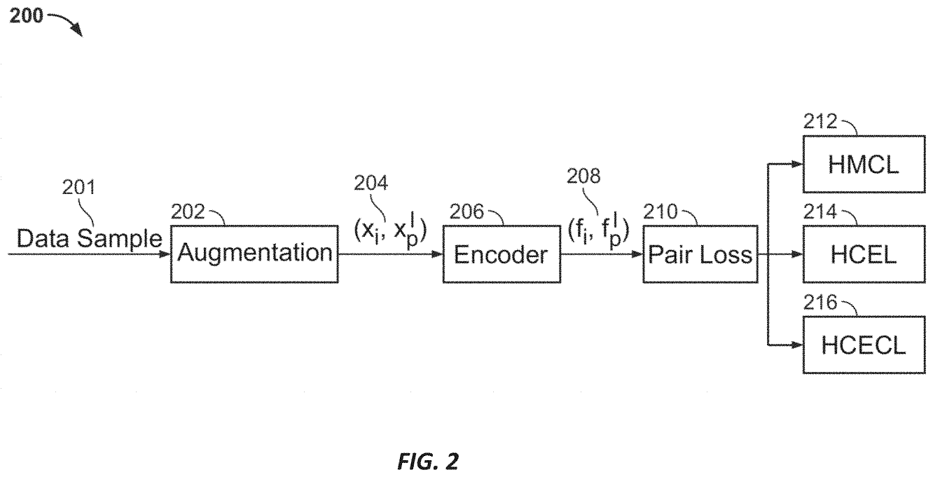

FIG. 2 is a simplified diagram illustrating a framework 200 for hierarchical contrastive learning with a hierarchical multi-label structure such as shown in FIG. 1B, according to embodiments described herein. Framework 200 is built upon a self-supervised contrastive learning framework, which pulls an anchor sample and its augmented versions together in the embedding space, while the anchor samples and negative samples are pushed apart.

In one embodiment, framework 200 may receive a data sample 201 that has a multi- label hierarchical structure having a set L of all label levels, similar to that shown in FIG. 1B. A set of N randomly sampled data samples is denoted as {xₖ, yₖ }where x denotes the data sample, and y denotes the series of multiple labels associated with the data sample, k =1, 2, . . ., N.

The framework 200 contains an augmentation module 202 that augments the data sample 201. For example, two augmentations, such as cropping, flipping, centering, color changing, and/or the like, are applied to each data sample in the training dataset. For each anchor data sample xᵢ, a positive sample xₚ^{l} may be paired with the anchor data sample at each level l ϵL such that the anchor data sample xᵢ and the positive sample xₚ^{l} share common labels from the root of the label hierarchy to the level l label.

The positive pair (xᵢ, xₚ^{l}) 204 is then fed to an encoder 206, which generates corresponding feature representations (fᵢ, fₚ^{l}) 208. For example, the encoder 206 may be a convolutional neural network (CNN), a recursive neural network (RNN), and/or the like.

The pair loss module 210 then computes the loss for the pair of the anchor sample, indexed by i and the positive sample at level l as:

$${L}^{pair} ( i , {p}_{l}^{i} ) = log \frac{exp ( {f}_{i} \cdot {f}_{p}^{l} / τ )}{{\sum }_{a ϵ {A}_{l} \backslash i} exp ( {f}_{i} \cdot {f}_{a} / τ )}$$

where f represents the feature vector in the embedding space, and τis a temperature parameter, and Aₗ is the index set of all augmented image samples on level l, e.g., all image samples that have a level l label.

The pair loss may then be used in computing different types of contrastive losses for updating the encoder 206.

In one embodiment, the HMCL module 212 may compute a HMCL loss based on the pair loss:

$${L}^{HMCL} = {\sum }_{l ϵ L} \frac{1}{\vert L \vert} {\sum }_{i ϵ {I}_{l}} \frac{- {λ}_{l}}{\vert {P}_{l} ( i ) \vert} {\sum }_{p ϵ {P}_{l}} {L}^{pair} ( i , {p}_{l}^{i} )$$

where Pₗ(i) represents the indices of all positives on level l except for i; λₗ =F(l) is a controlling parameter that applies a fixed penalty for each level in the hierarchy, and Pₗ is the set of positive images for anchor image indexed by i. F is heuristically chosen and scales inversely with the level l.

In one embodiment, the HCEL module 214 may enforce a hierarchical constraint in the representation learning setting. Specifically, in the classification setting, the hierarchical constraint may provide that if a data sample belongs to a class, the data sample should also belong to its ancestor classes of the particular class. A confidence score may then be defined such that when a class lower in the hierarchy cannot have a lower confidence score than the confidence score of a class higher in the ancestry sequence. When applying the confidence score to the contrastive learning scenario, the hierarchical constraint is then defined as the requirement that the loss between sample pairs from a lower level in the hierarchy will not be higher than the loss between pairs from a higher level. Thus, the maximum loss Lₘₐₓ^{pair} from all positive pairs at level l is computed as:

$${L}_{max}^{pair} ( l ) = {max}_{i ϵ {I}_{l}} {L}^{pair} ( i , {P}_{l}^{i} ) .$$

Then, the HCEL loss is computed as:

$${\sum }_{l ϵ L} \frac{1}{\vert L \vert} {\sum }_{i ϵ {I}_{l}} \frac{- 1}{\vert P ( i ) \vert} {\sum }_{p ϵ {P}_{l}} max ( {L}^{pair} ( i , {p}_{l}^{i} ) , {L}_{max}^{pair} ( l - 1 ) ) ,$$

HCEL is computed sequentially in increasing order of l such that the pair loss at level l can not be less than the maximum pair loss at level l— 1.

In one embodiment, the HCECL module 216 may also receive the pair loss for each positive pair at level l. For example, the HMCL loss may act as an independent penalty defined on each level, whereas the HCEL loss is a dependent penalty that is defined in relation to the losses computed at the lower levels. These two losses may be combined to form a Hierarchical Constraint Enforcing Contrastive Loss (HCECL):

$${\sum }_{l ϵ L} \frac{1}{\vert L \vert} {\sum }_{i ϵ {I}_{l}} \frac{- {λ}_{l}}{\vert P ( i ) \vert} {\sum }_{p ϵ {P}_{l}} max ( {L}^{pair} ( i , {p}_{l}^{i} ) , {L}_{max}^{pair} ( l - 1 ) ) .$$

In one embodiment, the combined loss may be viewed as adding the λl term to the HCEL loss, resulting in a loss term that has a fixed level penalty as well as the hierarchy constraint enforcing term.

The HMCL loss, HCEL loss or the HCECL loss may then be used to update the encoder network 206, e.g., via backpropagation.

In framework 200 that applied to the hierarchical multi-label setting, it is desirable for each batch of training samples (e.g., the data sample 201) to have sufficient representation from all levels of the hierarchy for each anchor sample. Thus, a custom batch sampling strategy may be devised in which each image can form a positive pair with images that share a common ancestry at all levels in the structure. Specifically, an anchor image may be randomly sampled from the training dataset, from which the label hierarchy may be established. For each label in the multi-label hierarchy, an image is randomly sampled in the sub-tree such that the anchor image and the sampled image have common ancestry up to the respective label. The sampling process may continue until each image from the batch is sampled only once in a training epoch.

For example, in the example label hierarchy shown in FIG. 1B, first, the anchor image 102 may be sampled. Positive pairings from each level may be sampled next. First, a random image from sub-category-1 will be sampled. Next, a random image from category-1 but not sub- category-1 will be sampled. This process is repeated at all levels in the hierarchy. Once completed, another anchor image is sampled randomly and the process repeats until each image from the batch has been sampled.

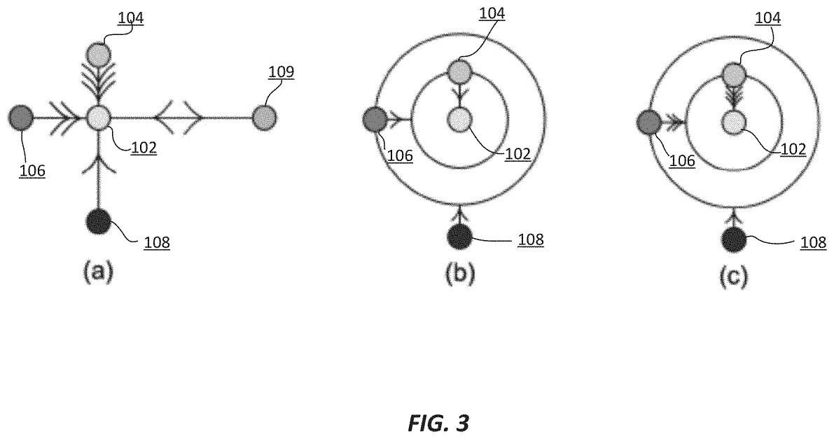

FIG. 3 provide an example visualization of the effects of the HMCL loss, HCEL loss and the combined HCECL loss on the data samples in the embedding space, according to embodiments described herein. FIG. 3(a) shows a conceptual illustration of the HMCL loss which is analogous to a penalty inversely proportional to the proximity in the label space and is enforced on each positive pair. The HMCL applies higher penalties to image pairs constructed from lower levels in the hierarchy, forcing them to be pulled closer than pairs constructed from higher levels in the hierarchy. For example, the anchor image 102 and the augmented image 104, which share all common labels, will be pulled the closest in the label space. The anchor image 102 and the subcategory image 104 which share the same labels from the root to the level of “subcategory 1,” will be pulled closer than the pair of the anchor image 102 and the category image 106, which only share the same labels up to the level “category.”

On the other hand, negative images 109 are pushed away from the anchor image 102. The HMCL loss takes all-level labels into consideration and minimizes the summation of loss corresponding to all levels of labels. If there is only one level of label, the HMCL loss reduces to the supervised contrastive loss:

$${L}^{sup} = {\sum }_{i ϵ I} \frac{- 1}{\vert P ( i ) \vert} {\sum }_{p ϵ P} log \frac{exp ( {f}_{i} \cdot {f}_{p} / τ )}{{\sum }_{a ϵ A \backslash i} exp ( {f}_{i} \cdot {f}_{a} / τ )} ,$$

where P represents the indices of all positives in the multi-view batches except for i. The supervised contrastive loss is therefore a special case of the HMCL.

FIG. 3(b) shows a conceptual visualization for the HCEL loss, in which pairs formed at higher levels in the hierarchy will not have a lower loss than pairs formed at a lower level in the hierarchy. A hierarchy constraint is enforced to ensure that image pairs that are farther away in the label space will not have a lower loss than image pairs that are closer. For example, from the anchor image 102, the distances of the augmented image 104, the subcategory image 106, and the category image 108 to the anchor image 102 are each bounded by their respective level of labels (as shown by the respective ring).

FIG. 3(c) shows a conceptual visualization for the combined (HCECL) loss, which applies the penalty in combination with the hierarchy preserving constraint. For example, from the anchor image 102, the augmented image 104 is the closest, the subcategory image 106 is the next, and the category image 108 is the farthest. At the same time, the distances are each bounded by their respective level of labels (as shown by the respective ring).

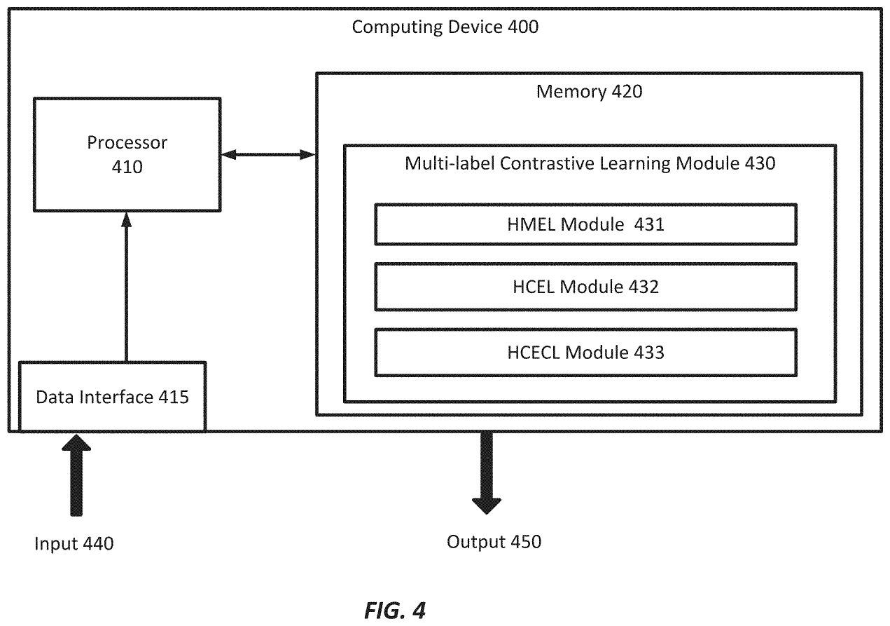

FIG. 4 is a simplified diagram of a computing device that implements a hierarchical multi-label contrastive learning framework, according to some embodiments described herein. As shown in FIG. 4, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine readable media. Some common forms of machine readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on- chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for a multi-label contrastive learning module 430 that may be used to implement and/or emulate the systems and models, and/or to implement any of the methods described further herein. In some examples, the multi-label contrastive learning module 430, may receive an input 440, e.g., such as unlabeled image instances, via a data interface 415. The data interface 415 may be any of a user interface that receives a user uploaded image instance, or a communication interface that may receive or retrieve a previously stored image instance from the database. The multi-label contrastive learning module 430 may generate an output 450, such as classification result of the input 440.

In some embodiments, the multi-label contrastive learning module 430 may further includes the HMCL module 431, the HCEL module 432 and the HCECL module 433. The HMCL module 431, the HCEL module 432 and the HCECL module 433 may exploit the relationship between hierarchical multi-labels and learn representations that maintain the label relation-ship in the representation space. The HMCL module 431 computes a HMCL loss (similar to that in module 212) that enforces a penalty that is dependent on the proximity between the anchor image and the matching image in the label space. In the hierarchical multi- label setting, proximity in the label space may be defined as the overlap in ancestry in the tree structure. The HCEL module 432 computes a HCEL loss (similar to that in module 214) that may prevent the hierarchy violation, that is, it ensures that the loss from pairs farther apart in the label space are never less than the loss from pairs that are closer. The HCECL module 433 computes a HCECL loss (similar to that in module 216) that may apply the penalty from the HMCL module 431 in combination with the hierarchy preserving constraint from the HCEL module 432.

In some examples, the multi-label contrastive learning module 430 and the sub- modules 431-232 may be implemented using hardware, software, and/or a combination of hardware and software.

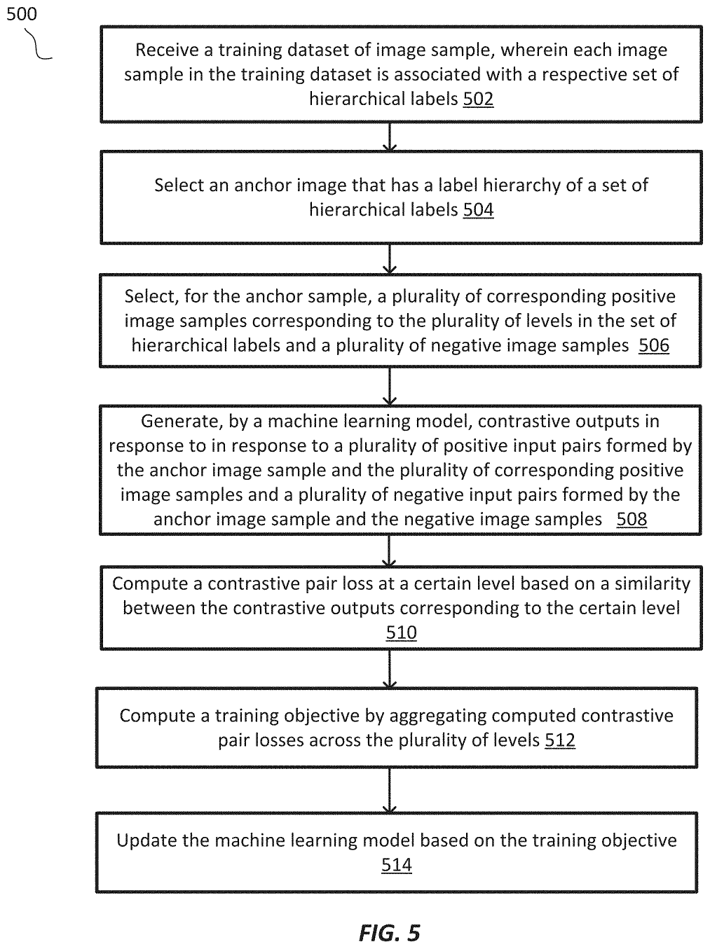

FIG. 5 is a simplified diagram of a method 500 for training a multi-view contrastive relational learning framework, according to some embodiments. One or more of the processes 502-514 of method 500 may be implemented, at least in part, in the form of executable code stored on non-transitory, tangible, machine-readable media that when run by one or more processors may cause the one or more processors to perform one or more of the processes 502- 514.

At step 502, a training dataset of image samples are received. Each image sample in the training dataset is associated with a respective set of hierarchical labels, e.g., similar to the tree structure of label hierarchy as shown in FIG. 1B.

At step 504, an anchor image is randomly selected from the training dataset. An anchor set of hierarchical labels in the tree structure associated with anchor image sample is then determined, for example, e.g., as shown by the node 102 representing an anchor image in FIG. 1B.

At step 506, for the at least anchor image sample, a plurality of corresponding positive image samples are randomly selected corresponding to the plurality of levels in the set of hierarchical labels and a plurality of negative image samples. For example, the category image 106 is a positive image sample to the anchor image 102 at the “category” level as shown in FIG. 1B. A positive pair is then formed from the anchor image sample and the first positive image sample, e.g., the input pair 204 as shown in FIG. 2.

At step 508, a machine learning model, such as an encoder, generates contrastive outputs in response to a plurality of positive input pairs formed by the at least one image sample and the plurality of corresponding positive image samples and a plurality of negative input pairs formed by the at least one image sample and the plurality of negative image samples. For example, an anchor representation and a first positive representation, e.g., pair 208, may be generated from the anchor image sample and the first positive image sample, by the encoder 206 as shown in FIG. 2.

At step 510, a contrastive pair loss is computed at a certain level based on a similarity between the contrastive outputs corresponding to the certain level, e.g., by the pair loss module 210 discussed in relation to FIG. 2.

At step 512, a training objective is computed by aggregating computed contrastive pair losses across the plurality of levels. For example, the training objected may be computed as the HMCL loss, e.g., by summing pair losses over positive image samples at each level and over the plurality of levels. For another example, the training objective may be computed as the HCEL loss, e.g., by determining, at each level from the plurality of levels, a respective maximum pair loss among positive pairs at the respective level subject to a condition that the respective maximum pair loss is no less than another maximum pair loss corresponding to a lower label level and summing maximum pair losses over positive image samples at each level and among the plurality of levels. For another example, the training objective may be computed as the HCECL loss.

At step 514, the machine learning model may be updated based on the training objective, e.g., via backpropagation.

In some embodiments, the training dataset may be divided into several training batches, and method 500 may repeat until each image sample in a training batch has been sampled.

In one embodiment, method 500 may repeat for several training epochs until until the machine learning model is sufficiently trained.

Example Performance

The HMCL, HCEL and HCECL losses described in FIGS. 2-5 may be applied on various downstream tasks, such as but not limited to image classification accuracy on categories, image retrieval accuracy on sub-categories and normalized mutual information (NMI) for clustering quality.

Two training datasets have been adopted: the DeepFashion In-Shop dataset described in Liu et al. Deepfashion: Powering robust clothes recognition and retrieval with rich annotations, in Proceedings of the IEEE/CVF Conference on Computer Vision and Pattern Recognition, pages 1096-1104, 2016, and the ModelNet40 dataset described in Wu et al., 3d shapenets: A deep representation for volumetric shapes, in Proceedings of the IEEE/CVF Conference on Computer Vision and Pattern Recognition, pages 1912-1920, 2015.

The DeepFashion dataset is a large-scale cloth dataset with more than 800K images. The In-Shop subset is adopted in the experiments with framework 200 as it has three-level labels: category, product ID and variation. The variation can be different colors or sub-styles for the same product. The clothes images are obtained from Forever21. There are 25,900 training images, 12,612 validation images and 14,218 test images, where query images are used as test images in the task of category classification. To show the effectiveness of the model generalization, the training images are classified into two sets: seen categories (9 categories) and unseen categories (8 categories). The model is first trained on seen categories, and then finetuned the classifier on unseen categories for the task of category classification. For the task of image retrieval, the features from the header are applied to calculate the feature distances between a query image and gallery images. Note that there is no overlap in categories between seen and unseen data, and there is no overlap in image IDs in train and test sets.

ModelNet40 is a synthetic dataset of 3,183 CAD models from 40 object classes. It has two-level hierarchical labels: category and image ID. Similar to DeepFashion In-Shop, data is split into 22 seen and 18 unseen categories. In the seen categories, the numbers of training, validation, and test images are 16,896, 4224, and 5,280, while in the unseen categories, the numbers of them are 13,662, 3,414, and 4,320. For the image retrieval task, the gallery dataset has 11,221 images and the query has 6,017. As there is no retrieval split that is provided by this dataset, the dataset is designed upon the validation/test ratio in DeepFashion In-Shop. The seen and unseen category splits on these two datasets are uniquely designed, where the number of seen and unseen categories are similar.

A pre-trained ResNet-50 as described in He et al., Deep residual learning for image recognition, in Proceedings of the IEEE/CVF Conference on Computer Vision and Pattern Recognition, pages 770-778, 2016, which was trained on ImageNet (see Deng et al., Deep residual learning for image recognition, in Proceedings of the IEEE/CVF Conference on Computer Vision and Pattern Recognition, pages 770-778, 2016, as the model backbone. The two datasets are fine tuned for 100 epochs. Specifically, the parameters of the fourth layer of the ResNet-50 as well as a multi-layer perceptron header (similar to Khosla et al., Supervised contrastive learning, arXiv preprint arXiv:2004.11362, 2020) on the seen dataset with the proposed losses. The optimizer is SGD with momentum as described in Ruder et al., An overview of gradient descent optimization algorithms. arXiv preprint arXiv:1609.04747, 2016. On the seen dataset, an additional linear classifier is trained for 40 epochs to obtain the top-k classification accuracy. On the unseen dataset, a linear classifier is trained as well for the task of category classification. The same setup is used for all models.

The batch size in the experiments is 512, and the temperature τis set as 0.1 in all experiments. The learning rate as 0.1, and decrease it by 10 for every 40 epochs. The augmentations are the same as applied in Khosla et al..

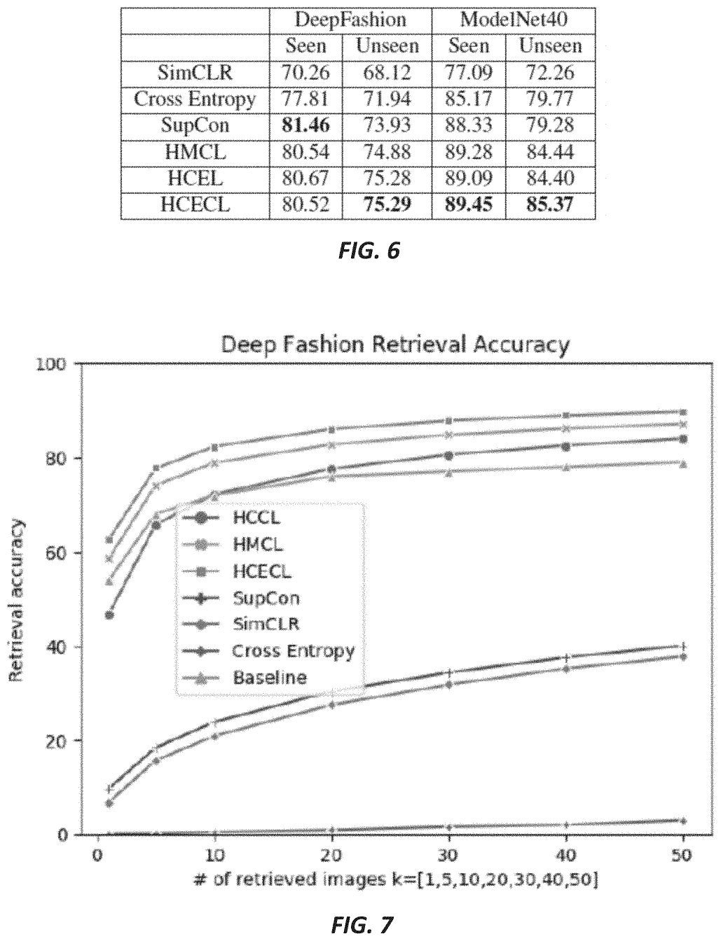

FIG. 6 provides an example data chart illustrating the top-1 accuracy of classification accuracy on datasets DeepFashion In-Shop and ModelNet40, according to embodiments described herein. The loss functions are compared with SimCLR, an unsupervised contrastive loss described in Chen et al., A simple framework for contrastive learn-ing of visual representations, in International Conference on Machine Learning, pages 1597-1607. PMLR, 2020 and two supervised learning losses functions: cross entropy and supervised contrastive loss (SupCon) described in Khosla et al. The cross entropy uses labels and the softmax to train a classifier, and SupCon uses positive samples to train a contrastive loss. SupCon shows that the traditional triplet loss described in Weinberger et al., Distance metric learning for large margin nearest neighbor classification, Journal of Machine Learning Research, 10:207-244, 2009, is a special case of it, and its performance is better than the triplet loss. Therefore, SupCon is chosen as one of the baselines in the experiments. The imageNet pretrained model is then finetuned on the seen dataset. To obtain results in the unseen dataset, the classifier is finetuned but the whole network that is trained on the seen dataset is frozen.

As shown in FIG. 6, it is seen that the proposed three methods obtain better results than the baselines on the unseen part of both datasets, while obtain comparable results to Sup- Con on the seen part. It means that the proposed loss functions HMCL, HCEL and HCECL have better generalization ability than the two base-line methods. In addition, HCECL may achieve the best top-1 accuracy on the unseen dataset, which means that the soft constraint penalty is critical to generalize the embedding feature learning.

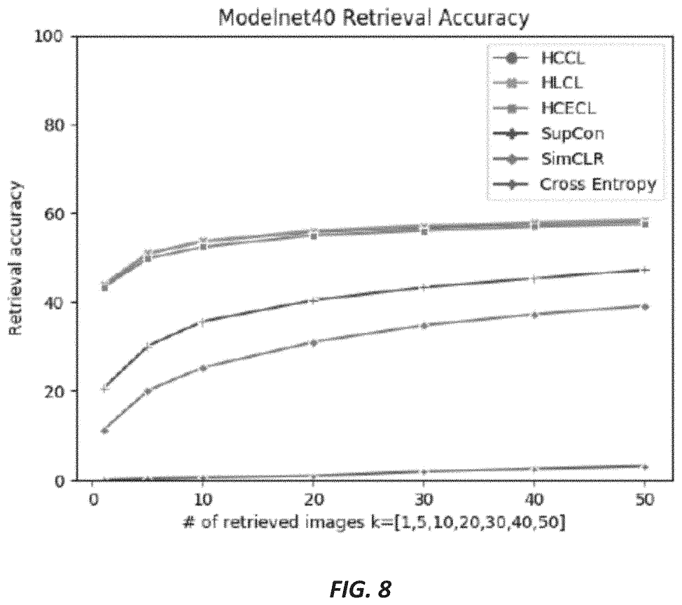

This downstream task here is to retrieve images from the gallery that are the same ID as the query image. The top-k accuracy is usually adopted to measure if a query image ID can be found in the top-k retrieved results from the gallery. In FIGS. 7-8, results of the proposed three losses versus the baselines on DeepFashion In-Shop dataset and Modelnet40 respectively. In addition, the results from the retrieval results graph in Liu et al. and added that as a baseline. It is shown that the proposed three losses consistently perform better. These results indicate that our embeddings manage to preserve the hierarchical relationship between labels in the representation space.

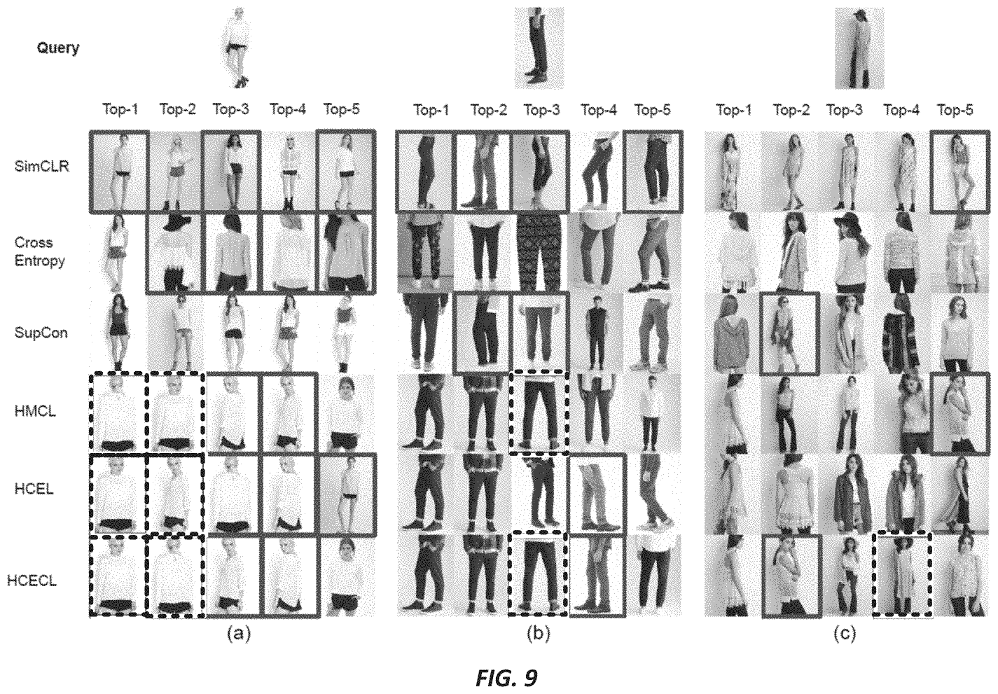

FIG. 9 show a visualization of the retrieved top-5 images by different algorithms. The top row has 3 query images, and rows below show their corresponding retrieved top-5 results. The dotted bounding boxes represent correct retrieved images. The blue bounding boxes represent wrong retrieved images but they are in the correct categories. In FIG. 9(a), the top-2 retrieved images of the three proposed algorithms are both correct. Although SimCLR and the cross entropy loss do not retrieve correct images, most retrieved images obtain correct categories. In FIG. 9(b), the query image is more challenging than (a). Retrieved images of SimCLR have the best number of correct categories (4), but the corresponding product IDs are not correct among all the 5 retrieved images. In contrast, the proposed HMCL and the HCECL can both retrieve correct images (top-3). Considering the fact that denims are very similar to pants and the fact that some denims look very similar to each other, e.g. the retrieved images from our proposed algorithms look very similar, our proposed losses have a powerful ability to distinguish similar products. The query image in FIG. 9(c) is the most challenging image in these three examples, as it has both tees and denims. Only HCECL retrieves the correct image, while all other methods, including the two individual losses that we propose, fail to find the correct product ID. Comparing the results of the proposed three losses to the three baselines, it is observed that most retrieved images of our algorithms re-turn a tee-denim combination, which is a reasonable context given the query image. Thus, the combined loss may have the most desirable performance best learning ability among all methods, with the model showing good separability at both the cate-gory and sub-category levels.

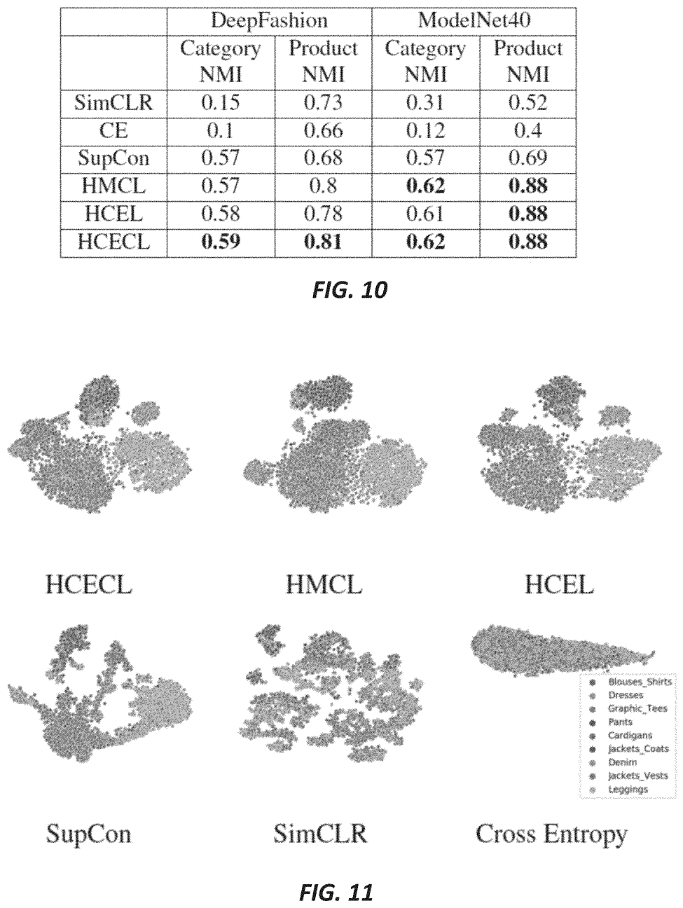

Clustering is another downstream task that can be used to evaluate the quality of the embeddings. As in Ho et al., Exploit clues from views: Self-supervised and regularized learning for multiview object recognition, in Proceedings of the IEEE/CVF Conference on Computer Vision and Pattern Recognition, pages 9090-9100, 2020, K-means and the NMI score described in Vinh et al., Information theoretic measures for clusterings comparison: Variants, properties, normalization and correction for chance. The Journal of Machine Learning Research, 11:2837- 2854, 2010, to evaluate clustering quality. We first generate the embeddings for all the images in the unseen test set, and perform K-means in the representation space. Clustering is done at two levels: category and ID. At the category level, K is set to the number of categories in the dataset, and NMI measures the consistency between the category labels and cluster ID. At the ID level, for each cateogry, K-means is performed, with K set to the number of products in that category. The mean of ID-level NMIs, across all categories, is reported in the Product NMI columns in FIG. 10. The significant improvement over the baseline in product NMI shows that our approach maintains separability for sub-categories within a category, and also shows that our approach preserves the hierarchical relationship between labels in the representation space.

FIG. 6 shows visualization of the test image embeddings into 2 dimensions through t- sne described in Maaten et al., Visualizing data using t-sne. Journal of Machine Learning Research, 9(11), 2008. The three proposed losses have a clear category level separability. Interestingly, the semantically similar categories, like Pants and Denim, as well as Cardigans and Jacket Coats are much closer to each other in the embedding space compared to unrelated categories. Although SimCLR and SupCon have separability of data points, this is not correlated with category labels, and there is significant mixing of different categories in the clusters from those approaches.

The sampling strategy becomes more relevant with an unbalanced tree structure, as random sampling from a skewed tree structure can lead to the network overfitting to sub-trees with higher image density. For instance, the ratio of image count in the largest and the smallest categories in Deep Fashion training set is over 30. In a statistical study, the random sampling strategy would result in no positive pairs (other than augmented versions of the same image) in over 20% of batches.

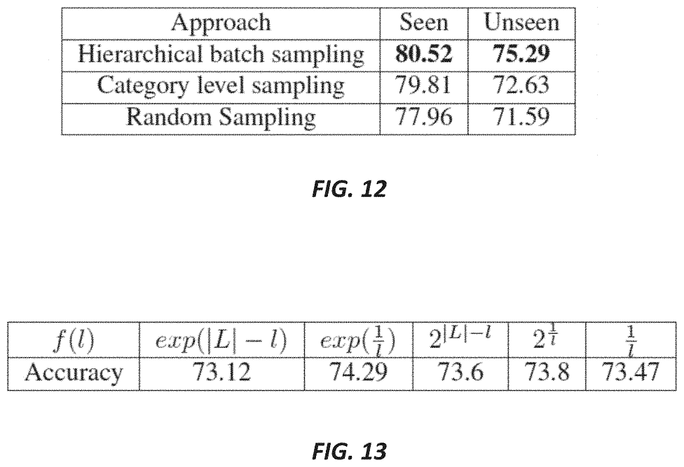

The efficacy of the hierarchical batch sampling strategy is shown by comparing its performance with a completely random strategy and a sampling strategy that only ensures multiple positive pairs at the category level. The experiments were all performed with the DeepFashion dataset, with the HCELC loss. All hyperparameters are kept constant throughout this set of experiments. FIG. 12 shows the results, a completely random sampling approach results in a significant deterioration in category prediction.

The guiding intuition in designing the penalty term in HMCL is that lower level pairs need to be forced closer than higher level pairs in the hierarchy. To that end, various functions for λ₁=F(1) are evaluated. The performance of category prediction is evaluated on the unseen data validation set for various f(l), and exp(1/l ) is the candidate picked for other experiments. Note that all of the functions described in FIG. 13 have an inversely proportional relationship with level l. Sanity check experiments are also performed where various functions that had a directly proportional results as well are evaluated, their performance was lower than those seen in the table shown in FIG. 13.

Some examples of computing devices, such as computing device 400 may include non-transitory, tangible, machine readable media that include executable code that when run by one or more processors (e.g., processor 410) may cause the one or more processors to perform the processes of method 500. Some common forms of machine readable media that may include the processes of method 500 are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well- known circuits, structures, or techniques have not been shown or described in detail in order not to obscure the embodiments of this disclosure Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A method for hierarchical multi-label contrastive learning, the method comprising:
receiving a training dataset of image samples, wherein the training data set comprises at least one image sample that is associated with a set of hierarchical labels at a plurality of levels;
selecting, for the at least one image sample, a plurality of corresponding positive image samples corresponding to the plurality of levels in the set of hierarchical labels and a plurality of negative image samples;
generating, by a machine learning model, contrastive outputs in response to a plurality of positive input pairs formed by the at least one image sample and the plurality of corresponding positive image samples and a plurality of negative input pairs formed by the at least one image sample and the plurality of negative image samples;
computing a contrastive pair loss at a certain level based on a similarity between the contrastive outputs corresponding to the certain level;
computing a training objective by aggregating computed contrastive pair losses across the plurality of levels; and
updating the machine learning model based on the training objective.

2. The method of claim 1, wherein the set of hierarchical labels takes a form of a tree structure according to the plurality of levels, and wherein the tree structure has a root corresponding to a broadest label of the set of hierarchical labels.

3. The method of claim 2, further comprising:
randomly selecting an anchor image sample from the training dataset;
determining an anchor set of hierarchical labels in the tree structure associated with anchor image sample;
randomly selecting, for the anchor image sample at a first level from the plurality of levels, a first positive image sample that shares common label ancestry from the root up to the first level with the anchor image sample; and
forming a first positive pair from the anchor image sample and the first positive image sample.

4. The method of claim 3, further comprising:
randomly selecting, for the anchor image sample at another level from the plurality of levels, another positive image sample until positive image samples according to the plurality of levels have been sampled.

5. The method of claim 4, further comprising:
randomly selecting another anchor image until a batch of training image samples have been sampled in a training epoch.

6. The method of claim 3, further comprising:
generating, by an encoder, an anchor representation and a first positive representation from the anchor image sample and the first positive image sample, respectively; and
computing a first pair loss corresponding to the first positive pair based on a distance between the anchor representation and the first positive representation in a feature space.

7. The method of claim 6, further comprising:
computing a loss objective based at least in part on summing pair losses over positive image samples at each level and over the plurality of levels.

8. The method of claim 6, further comprising:
determining, at each level from the plurality of levels, a respective maximum pair loss among positive pairs at the respective level subject to a condition that the respective maximum pair loss is no less than another maximum pair loss corresponding to a lower label level; and
computing a loss objective based at least in part on summing maximum pair losses over positive image samples at each level and among the plurality of levels.

9. A system for hierarchical multi-label contrastive learning, the system comprising:
a memory storing a plurality of processor-executable instructions for hierarchical multi- label contrastive learning; and
one or more hardware processors reading the plurality of processor-executable instructions to perform operations comprising:
receiving a training dataset of image samples, wherein the training data set comprises at least one image sample that is associated with a set of hierarchical labels at a plurality of levels;
selecting, for the at least one image sample, a plurality of corresponding positive image samples corresponding to the plurality of levels in the set of hierarchical labels and a plurality of negative image samples;
generating, by a machine learning model, contrastive outputs in response to a plurality of positive input pairs formed by the at least one image sample and the plurality of corresponding positive image samples and a plurality of negative input pairs formed by the at least one image sample and the plurality of negative image samples;
computing a contrastive pair loss at a certain level based on a similarity between the contrastive outputs corresponding to the certain level;
computing a training objective by aggregating computed contrastive pair losses across the plurality of levels; and
updating the machine learning model based on the training objective.

10. The system of claim 9, wherein the set of hierarchical labels takes a form of a tree structure according to the plurality of levels, and wherein the tree structure has a root corresponding to a broadest label of the set of hierarchical labels.

11. The system of claim 10, wherein the one or more hardware processors read the plurality of processor-executable instructions to further perform:
randomly selecting an anchor image sample from the training dataset;
determining an anchor set of hierarchical labels in the tree structure associated with anchor image sample;
randomly selecting, for the anchor image sample at a first level from the plurality of levels, a first positive image sample that shares common label ancestry from the root up to the first level with the anchor image sample; and
forming a first positive pair from the anchor image sample and the first positive image sample.

12. The system of claim 11, wherein the one or more hardware processors read the plurality of processor-executable instructions to further perform:
randomly selecting, for the anchor image sample at another level from the plurality of levels, another positive image sample until positive image samples according to the plurality of levels have been sampled.

13. The system of claim 12, wherein the one or more hardware processors read the plurality of processor-executable instructions to further perform:
randomly selecting another anchor image until a batch of training image samples have been sampled in a training epoch.

14. The system of claim 11, wherein the one or more hardware processors read the plurality of processor-executable instructions to further perform:
generating, by an encoder, an anchor representation and a first positive representation from the anchor image sample and the first positive image sample, respectively; and
computing a first pair loss corresponding to the first positive pair based on a distance between the anchor representation and the first positive representation in a feature space.

15. The system of claim 14, wherein the one or more hardware processors read the plurality of processor-executable instructions to further perform:
computing a loss objective based at least in part on summing pair losses over positive image samples at each level and over the plurality of levels.

16. The system of claim 14, wherein the one or more hardware processors read the plurality of processor-executable instructions to further perform:
determining, at each level from the plurality of levels, a respective maximum pair loss among positive pairs at the respective level subject to a condition that the respective maximum pair loss is no less than another maximum pair loss corresponding to a lower label level; and
computing a loss objective based at least in part on summing maximum pair losses over positive image samples at each level and among the plurality of levels.

17. A processor-readable non-transitory storage medium storing a plurality of processor- executable instructions for hierarchical multi-label contrastive learning, the plurality of processor-executable instructions being executed by one or more processors to perform operations comprising:
receiving a training dataset of image samples, wherein the training data set comprises at least one image sample that is associated with a set of hierarchical labels at a plurality of levels;
selecting, for the at least one image sample, a plurality of corresponding positive image samples corresponding to the plurality of levels in the set of hierarchical labels and a plurality of negative image samples;
generating, by a machine learning model, contrastive outputs in response to a plurality of positive input pairs formed by the at least one image sample and the plurality of corresponding positive image samples and a plurality of negative input pairs formed by the at least one image sample and the plurality of negative image samples;
computing a contrastive pair loss at a certain level based on a similarity between the contrastive outputs corresponding to the certain level;
computing a training objective by aggregating computed contrastive pair losses across the plurality of levels; and
updating the machine learning model based on the training objective.

18. The processor-readable non-transitory storage medium of claim 17, wherein the operations comprise:
randomly selecting an anchor image sample from the training dataset;
determining an anchor set of hierarchical labels in the tree structure associated with anchor image sample;
randomly selecting, for the anchor image sample at a first level from the plurality of levels, a first positive image sample that shares common label ancestry from the root up to the first level with the anchor image sample;
forming a first positive pair from the anchor image sample and the first positive image sample;
randomly selecting, for the anchor image sample at another level from the plurality of levels, another positive image sample until positive image samples according to the plurality of levels have been sampled; and
randomly selecting another anchor image until a batch of training image samples have been sampled in a training epoch.

19. The processor-readable non-transitory storage medium of claim 17, wherein the operations further comprise:
generating, by an encoder, an anchor representation and a first positive representation from the anchor image sample and the first positive image sample, respectively; and
computing a first pair loss corresponding to the first positive pair based on a distance between the anchor representation and the first positive representation in a feature space.

20. The processor-readable non-transitory storage medium of claim 19, wherein the operations further comprise:
determining, at each level from the plurality of levels, a respective maximum pair loss among positive pairs at the respective level subject to a condition that the respective maximum pair loss is no less than another maximum pair loss corresponding to a lower label level; and
computing a loss objective based at least in part on summing maximum pair losses over positive image samples at each level and among the plurality of levels.
